(19) United States
(12) Patent Application Publication
(10) Pub. No.: US 2014/0354859 A1
(43) Pub. Date: Dec. 4, 2014

(54) AUTOMATIC BANDING CORRECTION IN AN IMAGE CAPTURE DEVICE

(71) Applicant: QUALCOMM Incorporated, San Diego, CA (US)

(72) Inventors: Ying X. Noyes, San Diego, CA (US); Ruben Manuel Velarde, Chula Vista, CA (US); Tao Ma, San Diego, CA (US)

(73) Assignee: QUALCOMM Incorporated, San Diego, CA (US)

(21) Appl. No.: 14/025,496

(22) Filed: Sep. 12, 2013

Related U.S. Application Data
(60) Provisional application No. 61/828,531, filed on May 29, 2013.

(51) Int. Cl. H04N 5/235

(52) U.S. Cl. CPC H04N 5/235
USPC 348/241

(57) ABSTRACT

Certain embodiments relate to banding detection and correction techniques to improve the quality of captured imagery, such as video or still images. In particular, this disclosure describes banding correction techniques that cycle between detection of rolling banding and static banding to determine the power line frequency of ambient light, for example 50 Hz or 60 Hz. The banding correction techniques may also compare different image frames to detect rolling banding. The banding correction techniques may compare row sum data of a plurality of image frames and apply a Fourier analysis to determine a periodic signal of static banding at a particular ambient light power line frequency.

### CROSS-REFERENCE TO RELATED APPLICATIONS

The present application claims the benefit of U.S. Patent Application No. 61/828,531 filed May 29, 2013, entitled “AUTOMATIC BANDING CORRECTION IN AN IMAGE CAPTURE DEVICE” and assigned to the assignee hereof. The disclosure of this prior application is considered part of, and is incorporated by reference in, this disclosure.

### TECHNICAL FIELD

This disclosure relates to image capture devices and, more particularly, correction of banding within image capture devices.

### BACKGROUND

Image capture devices, such as digital video cameras or digital still photo cameras, are used in different applications and environments. An image capture device should be capable of producing high quality imagery under a variety of lighting conditions. For example, image capture devices should be capable of operating effectively in environments illuminated by natural light, such as outdoor environments, as well as in environments illuminated by incandescent or fluorescent lights, such as indoor environments.

Certain types of ambient lighting may degrade the quality of captured images, particularly in image capture devices employing complementary metal oxide semiconductor (CMOS) sensors. In an environment illuminated by artificial lighting, such as electric light fixtures and lamps, fluctuations in the intensity of the lighting can degrade the quality of the captured image. Such fluctuations are a function of the alternating current (AC) electrical power line frequency of the lighting source. An active-pixel sensor, such as CMOS sensor, includes an array of image sensors that do not instantaneously capture all of the image information used to record a frame. These types of devices typically employ a rolling shutter method of image acquisition, in which an image is exposed by scanning across the frame either vertically or horizontally, rather than capturing the entirety of the image at once. Therefore, not all parts of the image are captured at the same time. Consequently, fluctuations in light intensity during image capture may cause portions of an image frame to exhibit different intensity levels that may result in visible bands appearing in the image. This phenomenon is commonly referred to as “banding”.

Banding may be eliminated by setting the integration time, or exposure time, of the image capture device to an integer multiple of the period of the illumination source. The integration time refers to the time limit for the sensor array to capture light for each frame. Typically, banding is more severe for shorter integration times. Accordingly, one solution to this problem has been to program the frame rate of the image capture device such that the integration time is an integer multiple of the illumination source power line frequency. However, variations in the AC power frequency of indoor lighting exist throughout the world. Some countries use 60 Hertz (Hz) power, for example, while other countries use 50 Hz power. Some countries use both 50 and 60 Hz AC power, even within the same building in some instances.

Therefore, current implementations are not very robust because banding may occur when the image capture device is used in an environment in which the illumination source is operating at a frequency other than an anticipated frequency, or at multiple frequencies, and thus banding may not be corrected. Further, it may be important that a particular image capture device operate at a standard frame rate, such as 30 frames per second (fps). In such instances, integration time cannot be controlled to guarantee rolling bands, and static banding may occur.

### SUMMARY

One embodiment relates to a method, implemented in an image capture device, of detecting image banding, the method comprising: capturing a plurality of frames of an image at a selected framerate; attempting to correct banding artifacts in the captured plurality of frames using a first antibanding correction table; determining whether rolling banding is present in the captured plurality of frames at the selected framerate; and detecting whether rolling banding is present, wherein if rolling banding is present then selecting a second antibanding correction table configured to correct the rolling banding, and wherein if rolling banding is not present then using the first antibanding correction table to correct banding artifacts in the image capture device. Further embodiments may comprise cycling between determining whether one of static and rolling banding is present at a first power line frequency and determining whether the other of static and rolling banding is present at a second power line frequency.

Another embodiment relates to an image capture device comprising: at least one sensor configured to capture a plurality of image frames of a target image; a capture control unit configured to control the at least one sensor; and a banding correction unit configured to: receive the plurality of image frames, detect a type of banding present in the plurality of image frames, select an antibanding method based at least in part on the detected type of banding present, and use the antibanding method to generate a banding correction signal. In further embodiments, the type of banding may be one of rolling banding and static banding. The capture control unit may be further configured to receive the banding correction signal and to adjust the at least one sensor using the banding correction signal to substantially eliminate banding in the target image.

### BRIEF DESCRIPTION OF THE DRAWINGS

The disclosed aspects will hereinafter be described in conjunction with the appended drawings and appendix, provided to illustrate and not to limit the disclosed aspects, wherein like designations denote like elements.

FIG. 1A is a block diagram illustrating an exemplary image capture device for capturing image information;

FIG. 1B is a block diagram illustrating an exemplary embodiment of the banding correction unit of FIG. 1A;

FIG. 2 is a graph illustrating exemplary row sum plots for two consecutive image frames;

FIG. 3A is a graph illustrating an exemplary difference signal representing a difference between the frames of FIG. 2;

FIG. 3B is a graph illustrating the difference signal 300 of FIG. 3A, a smoothed difference signal 302 and a first derivative 304 of the smoothed difference signal for an exemplary pair of image frames;

FIGS. 4A-C illustrates an exemplary Fourier analysis representing a periodic signal in row sum data;

FIG. 5 illustrates an embodiment of an automatic banding detection process;

FIG. 6 is an embodiment of a static band detection and correction process; and

FIG. 7 is an embodiment of a rolling band detection and correction process.

### DETAILED DESCRIPTION

Embodiments relate to systems and methods of detecting image banding in an image capture device. In some cases, the image banding maybe due to changes in light intensity of a light source that is illuminating the subject due to power line fluctuations from alternating current. In one method, the image capture device captures a plurality of frames of a target image at a selected framerate. The image capture device can then attempt to correct any banding artifacts in the captured plurality of image frames using a first antibanding correction table. In some embodiments, the antibanding correction table may include values for exposure time/image gain. In this embodiment the antibanding table may include a series of sensor gain and exposure pairs that can be applied to the image capture device to reduce or remove banding artifacts in the captured images.

After the image capture device has attempted to correct for the banding artifacts, the device can then determine whether rolling banding is present at the selected framerate. If a rolling band is detected, then a second antibanding correction table can be accessed and used to correct the rolling banding. Using this process of defaulting to a first antibanding table, the system can correct for a majority of static banding artifacts relatively quickly and then use a second antibanding table configured to reduce rolling banding artifacts when the first antibanding table does not make a full correction.

Embodiments also relate to automatic banding detection and correction techniques to improve the quality of captured imagery, such as video or still images by comparing sequential image frames to determine if static banding or rolling banding is present. In particular, embodiments relate to banding correction techniques that cycle between detection of rolling banding and static banding to determine the power line frequency of ambient light, for example 50 Hz or 60 Hz. The banding correction techniques may compare different sequential image frames to detect rolling and/or static banding. In some embodiments, the comparison involves summing intensity values associated with rows within multiple image frames. In order to detect rolling banding, row sum data of two sequential frames may be compared to generate a difference signal, and the frequency of the ambient light may be determined by using a first derivative of the difference signal. In order to detect static banding, some embodiments may compare row sum data of a plurality of image frames and apply a Fourier analysis to determine a periodic signal of static banding at a particular ambient light power line frequency.

### System Overview

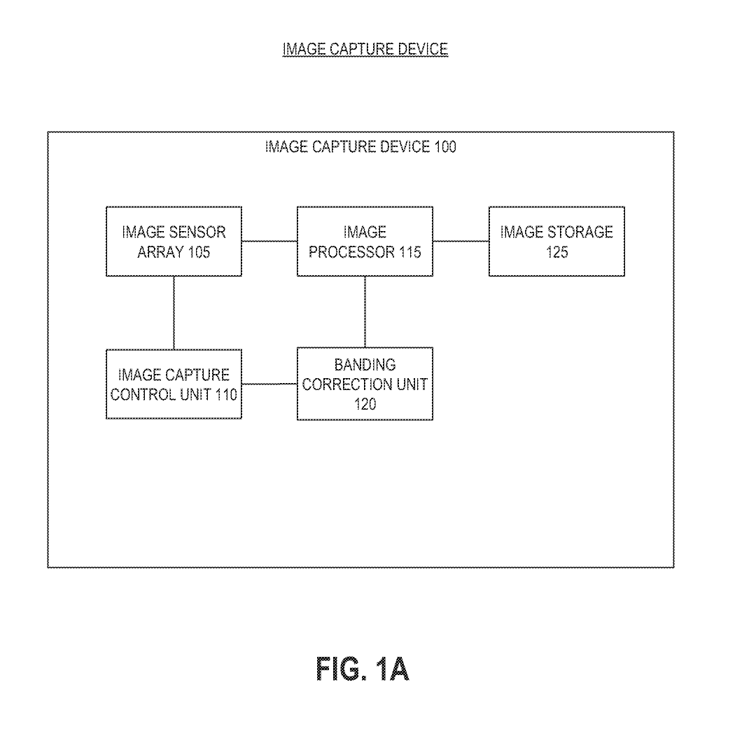

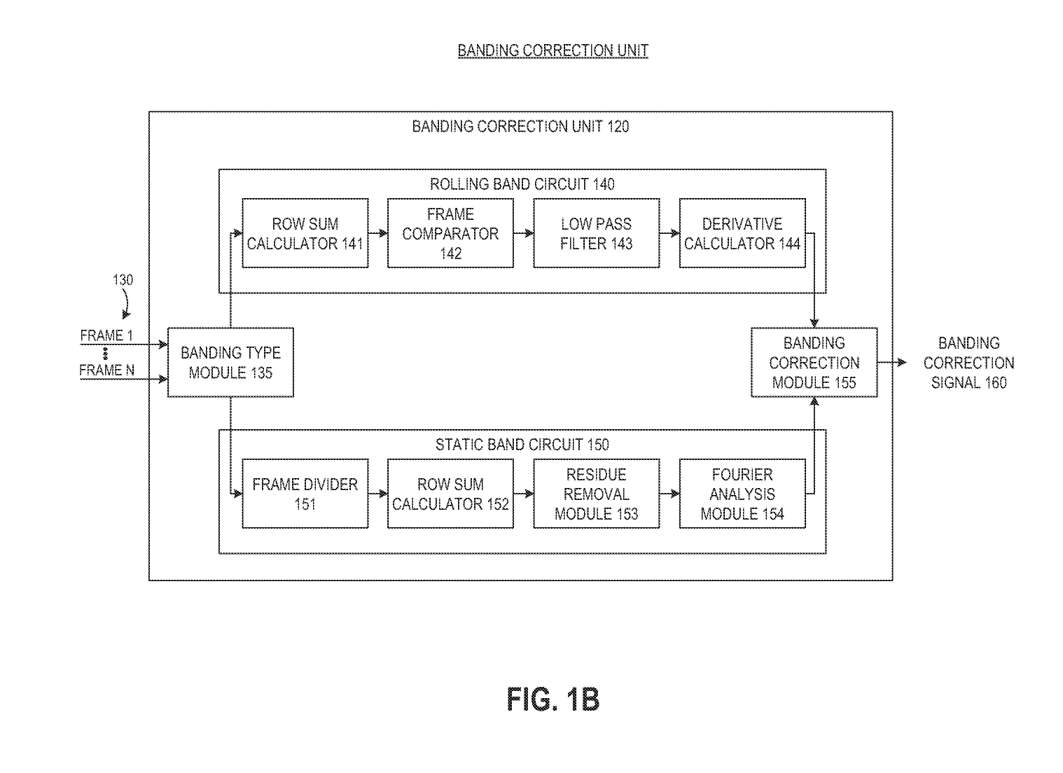

FIG. 1A is a block diagram illustrating an exemplary image capture device 100 for capturing image information, and FIG. 1B is a block diagram illustrating an exemplary embodiment of the banding correction unit of FIG. 1A. As shown in FIG. 1A, image capture device 100 may comprise an image sensor array 105, an image capture control unit 110, a banding correction unit 120, an image processor 115, and an image storage device 125. The features illustrated in FIGS. 1A and 1B may be realized by any suitable combination of hardware and/or software components. Depiction of different features as units is intended to highlight different functional aspects of image capture device 105, and does not necessarily imply that such units must be realized by separate hardware and/or software components. Rather, functionality associated with one or more units may be integrated within common hardware and/or software components.

Image capture device 100 may be a digital camera, such as a digital video camera, a digital still image camera, or a combination of both. In addition, image capture device 100 may be a stand-alone device, such as a stand-alone camera, or be integrated in another device, such as a wireless communication device. As an example, image capture device 100 may be integrated in a mobile telephone to form a so-called camera phone. Image capture device 100 preferably is equipped to capture color imagery, black-and-white imagery, or both. In this disclosure, the terms “image,” “imagery,” “image information,” or similar terms may interchangeably refer to either video or still pictures. Likewise, the term “frame” may refer to either a frame of video or a still picture frame obtained by image capture device 100.

Sensor array 105 may acquire image information for a scene of interest. Sensor array 105 may comprise a two-dimensional array of individual image sensors, e.g., arranged in rows and columns. Sensor array 105 may comprise, for example, an array of solid state sensors such as complementary metal-oxide semiconductor (CMOS) sensors. The image sensors within sensor array 105 are sequentially exposed to the image scene to capture the image information. Image capture device 100 sets an integration time for sensor array 105, limiting the amount of time to which the sensor array is exposed to light for capture of a given frame. Sensor array 105 provides captured image information to image processor 115 to form one or more frames of image information for storage in image storage device 125.

In one embodiment, the solid state sensors in sensor array 105 do not instantaneously capture all of the image information used to record a frame. Instead, the sensors are sequentially scanned to obtain the overall frame of image information. As a result, indoor lighting can produce visible banding, referred to as banding, in the images obtained by sensor array 105. The integration time of sensor array 105 can be controlled to eliminate banding caused by an illumination source operating at a given AC frequency. In particular, the integration time may be adjusted to be an integer multiple of a period of the illumination source. However, the frequency of illumination sources can be different, e.g., either 50 Hz or 60 Hz. Accordingly, the integration time required to eliminate banding may vary according to the environment in which image capture device 100 is used.

Image capture control unit 110 controls sensor array 105 to capture the image information in the form of one or more frames. Specifically, capture control unit 110 controls the exposure of sensor array 105 to the image scene based on a selected integration time and frame rate. This may be set automatically or may be set manually by a user. The frame rate at which sensor array 105 captures frames may affect whether band “rolls” or is static in a captured image. The band “rolls” when the positions of bands change slightly from frame to frame. If the band does not roll, then the band appears as a static line in the image. Capture control unit 110 may be in communication with the banding correction unit 120 to send information to the banding correction unit 120 about the currently selected frame rate and integration time. Capture control unit 110 may also provide the banding correction unit 120 with information regarding whether to detect static or rolling banding.

Image processor 115 receives the captured image data from sensor array 105 and performs any necessary processing on the image information. Processor 115 may, for example, perform filtering, cropping, demosaicing, compression, image enhancement, or other processing of the image information captured by sensor array 105. Processor 115 may be realized by a microprocessor, digital signal processor (DSP), application specification integrated circuit (ASIC), field programmable gate array (FPGA), or any other equivalent discrete or integrated logic circuitry. In some embodiments, image processor 115 may form part of an encoder-decoder (CODEC) that encodes the image information according to a particular encoding technique or format, such as MPEG-2, MPEG-4, ITU H.263, ITU H.264, JPEG, or the like.

Processor 115 stores the image information in storage device 125. Processor 115 may store raw image information, processed image information, or encoded information in storage device 125. If the imagery is accompanied by audio information, the audio also may be stored in storage device 125, either independently or in conjunction with the video information. Storage device 125 may comprise any volatile or non-volatile memory or storage device, such as read-only memory (ROM), electrically erasable programmable read-only memory (EEPROM), or FLASH memory, or such as a magnetic data storage device or optical data storage device.

Banding correction unit 120 detects banding within the image information captured by sensor array 105 and corrects the banding for subsequent images to improve image quality. As will be described in detail below, banding correction unit 120 detects banding within the image information using a plurality of frames of image information, and may detect both rolling and static banding in the plurality of frames. The banding correction unit 120 may cycle between detecting rolling banding and static banding in order to determine what frequency of antibanding table to use for banding correction. An antibanding table may be an exposure time/gain combination table. The antibanding table may include a series of sensor gain and exposure pairs. Antibanding table values may be organized by size, for example beginning with small values and ending with large values. An auto exposure algorithm may select a pair exposure/gain values to use based on scene brightness, and antibanding exposure settings can be built in the antibanding table.

Banding correction unit 120 may be implemented as an independent hardware component or as a programmable feature of a logic device, such as a microprocessor, DSP or the like. In some embodiments, banding detection unit 120 may be a programmable or integrated feature of a logic device implementing image processor 115. In particular, banding detection unit 120 may be implemented as one or more software processes executed by such a logic device.

Banding correction unit 120 may receive information from capture control unit 110 regarding a currently selected integration time of the capture device 100. As discussed above, the selected frame rate will determine whether banding rolls or is static at a certain power line frequency. Static banding may be challenging to distinguish from images containing light and dark patterns that mimic periodic illumination signals, for example a bookshelf or shadows created by sunlight passing through slatted wood. To avoid false negatives in identification of static banding, as will be discussed in more detail below, each frame may be divided into regions and each region analyzed separately. To avoid false positives in identification of rolling banding, banding correction unit may repeat the sequential frame row sum difference.

Banding correction unit 120 may perform banding detection when image capture device 100 is initially powered on. For example, banding correction unit 120 may initially perform banding detection when auto exposure control (AEC) of image capture device 100 reaches a particular brightness level range. In addition, banding correction unit 120 may periodically perform banding detection while image capture device 100 is operating, e.g., at intervals of several seconds or minutes. As one example, banding correction unit 120 may perform banding detection approximately every twenty seconds. In this manner, banding detection can be performed in the event the environment in which image capture device 100 is used has changed, which could result in the onset of banding or a change in banding frequency.

Banding detection unit 120 may, in some embodiments, begin a banding detection process by using a 60 Hz antibanding table. In an environment with a 50 Hz power line frequency for ambient lighting, at 30 fps the band will roll. Using the 60 Hz antibanding table will allow the banding correction unit 120 to detect rolling banding, and then the 50 Hz antibanding table may be used for banding correction. If no rolling banding is detected then the 60 Hz antibanding table may be used for banding correction.

In order to detect rolling banding, the banding correction unit 120 compares two frames obtained by sensor array 105 to detect banding. Preferably, the banding correction unit 120 compares consecutive frames, such as consecutive video frames in a video sequence or consecutive still images. However, the frames need not be consecutive. In either case, banding correction unit 120 uses the frame comparison to either identify a periodic pattern indicative of banding or identify the operating frequency of the illumination source. Banding correction unit 120 may sum intensity values across at least a portion of sensors in at least a portion of the rows in the sensor array 105 for both of the frames.

For example, banding correction unit 120 may use YCbCr luminance and chrominance data produced by sensor array 105. More particularly, banding correction unit 120 may use the Y luminance component of the YCbCr data as the intensity value for each sensor, and sum the Y values across the rows to produce row sum intensity values. The YCbCr data used by banding correction unit 120 may be the same data used to drive a viewfinder or other display associated with image capture device 100, and may be cropped and scaled. Banding correction unit 120 subtracts the row sums of the first frame from the corresponding row sums of the second frame to obtain a difference signal and then clip all negative values to zero. Positive values also may be clipped to zero while keeping only negative values. In some embodiments, banding correction unit 120 may apply a low pass filter to the difference signal to remove hand jitter or motion between the frames, and thereby produce a smoothed difference signal.

Banding correction unit 120 computes the first derivative of the filtered difference signal and locates the zero crossing points of the derivative signal. Using the zero crossing points of the derivative signal, banding correction unit 120 determines whether a periodic pattern indicative of banding is present in the image frames. Alternatively, banding correction unit 120 determines the operating frequency of the illumination source using the zero crossing points of the derivative signal. Banding correction unit 120 corrects the banding based on these determinations.

In order to detect stationary banding, banding correction unit 120 may user a Fourier analysis to approximate row sum data for a plurality of frames. For example, eight-level Fourier series decomposition may be used to substantially eliminate high frequencies in the row sum data. Some embodiments may process six frames at a time to determine static banding. Each frame provides information that may be used to determine banding present in the image, and cumulative banding data may be useful where bands are missing in certain frames or where foreground objects moving through a background obscure banding data. However, banding correction unit 120 may process more or less frames dependent upon the processing bandwidth that is available for banding correction.

When the banding frequency is not an integer, for example when 3.9 bands are present in an image frame, or where separate bands are detected for foreground and background objects, it may be difficult to determine the number of bands present in the frame. Accordingly, a sliding window method may be employed to detect the number of bands in an image frame. A first band may be detected at a first edge of the frame, and then processing may transition or “slide” to a second edge of the frame and detect a second band. A ratio between the energy of target frequency and the total energy may be used to determine the number of bands which exist in the frame between the first and second band.

Some embodiments may divide an image into N vertical regions. Row sum data may then be approximated for each region separately, and static band detection may also be performed separately in each region. If any one region has a static band, then it may be determined that a static band is present in the whole image. This approach may offer improved robustness of static band detection in images where only a portion of an image has no periodic pattern, as the periodic pattern in the other portions may interfere with static band detection in those portions. Static bands may be more easily detected in a vertical slice of an image with no periodic pattern or other disturbing elements.

Looking also now at FIG. 1B, the components of the banding correction unit 120 will now be described in greater detail. The banding correction unit 120 includes a banding type module, a rolling band circuit 140, a static band circuit 150, and a banding correction module 155. The rolling band circuit 140 may include a first row sum calculator 141, a frame comparator 142, a low pass filter 143, and a derivative calculator 144. The static band circuit 150 may include a frame divider 151, a second row sum calculator 152, a residue removal module 153, and a Fourier analysis module 154. The various components of banding correction unit 120 may be realized by different hardware and/or software components, or common hardware and/or software components. In some embodiments, such components may be implemented as programmable functionality of a common logic device, such as a microprocessor or DSP. As described above, the banding correction unit 120 detects and corrects banding within the image information based on a comparison of frames of image information. The banding correction unit 120 may also be used to determine whether a particular type of banding, such as static banding or rolling banding, is present, and if the banding is present.

Information regarding a plurality of frames 130 are input into the banding type module 135 (labeled “FRAME 1” . . . “FRAME N” in FIG. 1B). For example, intensity values of each of a plurality of pixels in FRAME 1 through FRAME N may be input into the banding type module 135. The banding type module 135 may receive the intensity values for FRAME 1 through FRAME N directly from sensor array 105, from storage device 125, or a combination thereof. In one embodiment, FRAME 1 through FRAME N are consecutively captured frames. In some embodiments, however, the techniques described herein also may be applied for non-consecutive frames.

The banding type module 135 routes at least some of the plurality of frames 130 to the rolling band circuit 140 or static band circuit 150 based on a type of banding which the banding correction unit 120 is being used to detect or correct. For example, in one embodiment the image capture control unit 110 of the image capture device 100 may transmit information to the banding type module 135 regarding whether to detect static or rolling banding. In another embodiment, the banding type module 135 may send at least some of the plurality of frames 130 to each of the rolling band circuit 140 and the static band circuit 150 in order to determine whether rolling or static banding is present. In some embodiments, two frames (referred to as “FRAME 1” and “FRAME 2” herein) may be output to the rolling band circuit 140 if the banding correction unit 120 will try to detect rolling banding, and six frames (referred to as “FRAME 1 through FRAME 6” herein) may be output to the static band circuit 150 if the banding correction unit 120 will try to detect static banding. However, more than two frames may be output to the rolling band circuit 140, and more or less than six frames may be output to the rolling band circuit 140.

The banding type module 135 may pass at least a portion of the plurality of frames 130 to the rolling band circuit 140. The first row sum calculator 141 may receive intensity values for FRAME 1 and FRAME 2 from the banding type module 135. A minimum of two frames is necessary for the rolling band circuit to detect rolling banding through determining intensity value differentials between the two frames. However, more than two frames may be used for improved robustness. Row sum calculator 141 may process one frame at a time or process two buffered frames. For example, row sum calculator may first process FRAME 1, buffer the results, and then process FRAME 2. Row sum calculator 141 sums the sensor intensity values across at least a portion of the sensors in at least a portion of the rows in each frame. Hence, it is not necessary to sum intensity values for all rows or all sensors of sensor array 105. If row sum calculator 141 sums each of the rows of the frames output by a sensor array 105 with 1200 rows, row sum calculator 141 computes row sum data with 1200 data points. Alternatively, row sum calculator 141 may group a number of rows together and calculate a single row sum for the entire group. For a sensor array with 1200 rows, for example, row sum calculator 141 may generate groups of four rows and calculate a single row sum for each group, resulting in row sum data with 300 data points. In the example, a group of four rows is combined to produce a single row sum.

In addition, to reduce the amount of computation performed by row sum calculator 141, a portion of the rows in each of the groups may not be used in the row sum calculation. Using the four row groups described above as an example, row sum calculator 141 may sum the intensity values of the first two rows of the group and skip the other two rows of the group. As a further alternative, row sum calculator 141 may use each of the sensor outputs in the row sum calculation or may only use a portion of the sensor outputs of sensor array 105. For example, row sum calculator 141 may use a subset of the sensors in each row or row group of the sensor array 105. A subset of sensors corresponds to a subset of columns of sensor array 105. Row sum calculator 141 may compute the row sums serially or in parallel.

Frame comparator 142 computes the differences between the row sum values calculated by row sum calculator 141 for FRAME 1 and FRAME 2 to obtain a “difference signal”. Specifically, frame comparator 142 subtracts row sums for FRAME 1 from the corresponding row sums for FRAME 2. Calculating the difference of the row sums of consecutive frames eliminates scene information, but maintains any rolling banding information. Frame comparator 142 may also clip any negative or positive portion of the difference signal to zero.

As further shown in FIG. 1B, banding correction unit 120 may apply a low pass filter 143 to the difference signal. Low pass filter 143 removes unwanted high frequency patterns from the difference signal. For example, low pass filter 143 may reduce the effects caused by hand jitter or motion between the two frames, resulting in a filtered, smoothed difference signal. Low pass filter 143 serves to smooth the difference signal to eliminate spurious information. Derivative calculator 144 then computes the first derivative of the filtered difference signal.

The first derivative signal is sent to the banding correction module 155 for use in determining whether rolling banding is present and, if rolling banding is present, for use in correcting banding artifacts in the image capture device 100. The banding correction module 155 may locate the zero crossing points of the first derivative signal, which correspond to the peak values of the filtered difference signal. The banding correction module 155 may compute the distances between the zero crossing points and the standard deviation of the distances between zero crossing points. The capture control unit 110 provides information on a current integration time of the camera. If the distances between the zero crossing points correspond to a periodic signal at a frequency which would cause rolling banding at the current integration time of the camera, then rolling banding is present in FRAME 1 and FRAME 2. The banding correction module 155 may then use the zero crossing points of the first derivative signal to generate a banding correction signal 160. The banding correction module 155 may also generate a banding correction signal 160 based on a determined frequency of the periodic signal. If the banding correction module 155 determines that no periodic signal is present, then the banding correction module 155 may output a signal indicating that no rolling banding is present.

The banding type module 135 may pass at least a portion of the plurality of frames 130 to the static band circuit 150. The frame divider 151 may receive intensity values of FRAME 1 through FRAME 6 from the banding type module 135. Processing six frames, in an exemplary embodiment, allows for acceptably accurate detection of static bands, however the static band circuit 150 may process more or less than six frames dependent upon the processing bandwidth that is available for banding correction. The frame divider 151 may vertically divide each of FRAME 1 through FRAME 6 into N vertical regions. This may advantageously provide less false negatives in detecting static banding, as row sum data may be approximated for each region separately, and static band detection may also be performed separately in each region. As discussed above, this approach may offer improved robustness of static band detection in images where only a portion of an image has no periodic pattern, as the periodic pattern in the other portions may interfere with static band detection in those portions. Static bands may be more easily detected in a vertical slice of an image with no periodic pattern or other disturbing elements. Thus, the frame divider 151 may be configured to analyze the intensity values of FRAME 1 through FRAME 6 to detect a region that is substantially from a periodic pattern and to output just that region as the divided region to the second row sum calculator 142. In other embodiments, the frame divider 151 may be configured to divide each of FRAME 1 through FRAME 6 into N divided regions. The divided regions may all be the same width or the widths of the divided regions of a frame may vary.

The second row sum calculator 152 may receive intensity values for the divided portion(s) of FRAME 1 through FRAME 6 output by the frame divider 151. Regarding the summing of row sum values, the second row sum calculator 152 may operate in a similar manner to the first row sum calculator 142 described above, however the second row sum calculator 152 sums the intensity values of the row separately in each divided region. Row sum calculator 152 may process one divided region at a time or may process some or all of the divided regions of FRAME 1 through FRAME 6 together as buffered frames. Row sum calculator 152 may employ a sliding window method, in which a portion of the rows at the top of a divided region are summed and a portion of the rows at the bottom of a divided region are summed. The summed portions may be analyzed for a partial periodic signal by the subsequent modules of the static band circuit 150, and a periodic signal may be extrapolated from the partial periodic signals, if such partial periodic signals are present. Using the sliding window method may reduce processing required for the row sum calculator 152 to compute row sum values.

Residue removal module 153 receives the row sum values from the row sum calculator 152. If no static banding is present, the row sum data may not resemble a periodic pattern of light at a power line frequency, and if objects in the target scene exhibit a periodic pattern, then a periodic static banding signal may not be detectable. Residue removal module 153 may perform a preliminary analysis of the input row sum data to determine if a periodic signal is likely present or detectable in the region. If residue removal module 153 determines that a periodic signal is unlikely to be present or detectable in a divided region, some or all of the subsequent modules in static band circuit 150 may not be used to analyze the data of that particular divided region. The static band circuit 150 may proceed to analyze another divided region, or if there are no further divided regions to analyze and no static banding was found in a previously analyzed divided region, banding correction module 155 may output a signal that no static banding is present.

In a region of a frame which does not contain a periodic pattern due to objects present in the target scene, row sum data will approximately resemble a periodic signal if static banding is present. However, residue present in the row sum data causes the row sum data to be an imperfect representation of a periodic signal. The residue removal module 153 approximates the residue in a divided region and subtracts the residue from the row sum data, generating a signal approximation. If static banding is present, the signal approximation closely resembles a periodic signal, however portions of the periodic signal may be skewed due to objects or artifacts present in the divided region. The Fourier analysis module 154 then performs a Fourier transform on the signal approximation, which may in some embodiments be an eight-level Fourier series decomposition, to eliminate high-frequencies in the row sum data. If static banding is present, the resulting signal is a periodic signal at the frequency of the power line of ambient light.

The resulting signal is sent to the banding correction module 155, which may locate the zero crossing points of the resulting signal and compute the distance between the zero crossing points. The capture control unit 110 provides information on a current integration time of the camera. If the distances between the zero crossing points correspond to a periodic signal at a frequency which would cause static banding at the current integration time of the camera, then static banding is present in FRAME 1 through FRAME 6. If any one region of the divided regions is determined to have a static band, then it may be determined that a static band is present in the whole frame or in all of FRAME 1 through FRAME 6. The banding correction module 155 may generate a banding correction signal 160 based on a determined frequency of the periodic signal. If the banding correction module 155 determines that no periodic frequency is present in the resulting signal, then the banding correction module 155 may output a signal indicating that no static banding is present.

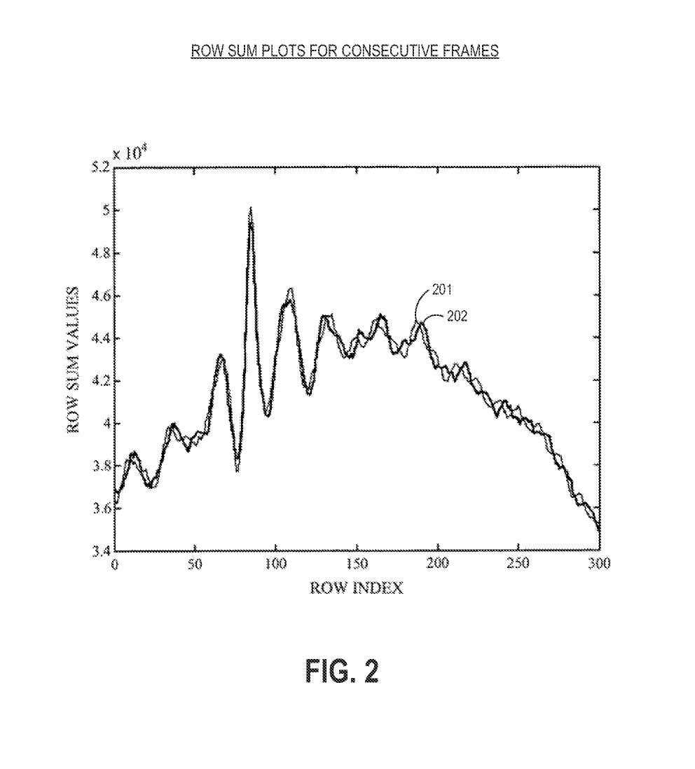

FIG. 2 is a graph illustrating exemplary row sum plots 201 and 202 of two consecutive frames used for detection of rolling banding. Row sum plot 201 corresponds to the output of row sum calculator 141 for a first frame and row sum plot 202 corresponds to the output of row sum calculator 141 for a second frame. The first and second frames may be consecutive or non-consecutive frames obtained by image capture device 100, although consecutive frames may be preferred. In the graph illustrated in FIG. 2, each of the row sum data plots has 300 row sum data points. The x axis in FIG. 2 corresponds to a row index, which identifies the particular row or group of rows for each data point. The y axis in FIG. 2 corresponds to a row sum intensity value.

Each data point represents the row sum for a particular row or group of rows in sensor array 105. For a sensor array with 1200 rows, for example, row sum calculator 141 may compute row sums intensity (e.g., Y from YCbCr data) for groups of four rows, resulting in calculation of 300 row sum data points. If the sensor array is 1200 rows by 1200 columns, then each of the 300 rows includes 1200 pixels. As described above, to reduce the amount of computation performed by row sum calculator 141, a portion of the rows in the group may not be used in the row sum calculation. For a group of four rows in each row sum data point, row sum calculator 141 may sum the first two rows of the group and skip the other two rows of the group. In addition, row sum calculator 141 may use each of the sensor outputs in the row sum calculation or may only use a portion of the sensor outputs of sensor array 105.

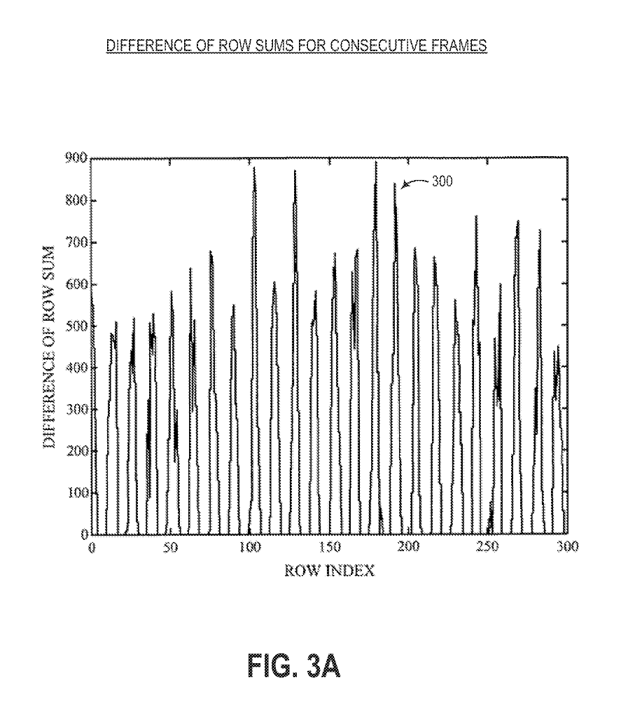

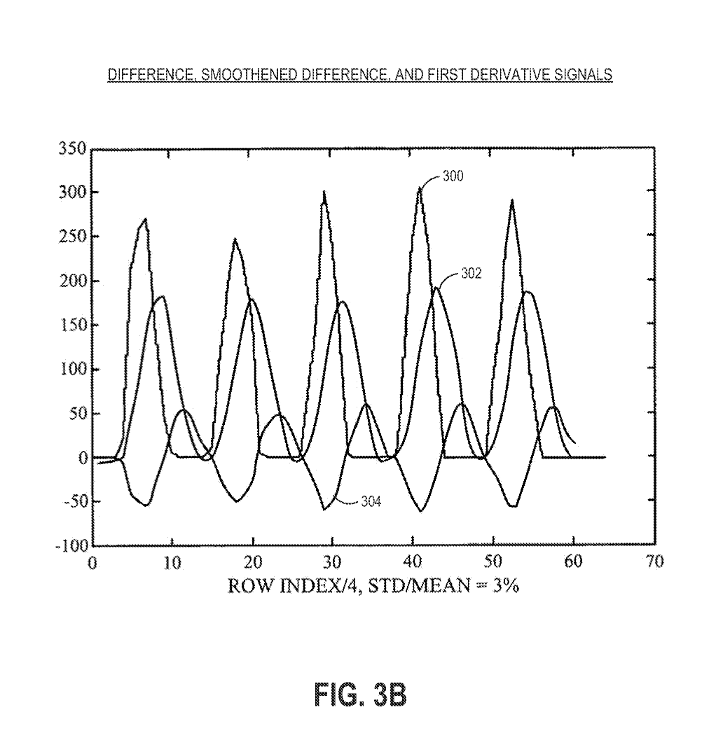

FIG. 3A is a graph illustrating an exemplary difference signal 300 used for detecting rolling banding, which may be calculated by the frame comparator 142 of FIG. 1B. Difference signal 300 is the result of subtracting row sum plot 201 from row sum plot 202 (FIG. 2) and clipping the negative portion of the signal to zero. In FIG. 3A, the x axis corresponds to the row index, which identifies the particular row or group of rows for each data point. The y axis in FIG. 3A corresponds to the row sum difference intensity value.

FIG. 3B is a graph illustrating the difference signal 300 of FIG. 3A, a smoothed difference signal 302 and a first derivative 304 of the smoothed difference signal for a pair of image frames. Difference signal 300 may be produced by frame comparator 142. Smoothed difference signal 302 may be produced by low pass filter 143. First derivative 304 may be produced by derivative calculator 144. The example imagery to which the signals in FIG. 3B correspond is a relatively simple image with little color and/or spatial detail. Difference signal 300 is a signal illustrating the difference between the row sum plots of two consecutive frames with negative values clipped to zero. Smoothed difference signal 202 is a signal illustrating the difference signal after application of low pass filter 143. Derivative signal 304 is the first derivative of smoothed difference signal 302.

As illustrated in FIG. 3B, the zero crossing points of derivative signal 304 correspond to the peak values of smoothed difference signal 302. Banding correction unit 120 corrects banding in the frames using the distance between zero crossing points. In one embodiment, for example, banding correction unit 120 computes the power frequency of the ambient light source using the distances between the zero crossing points, and corrects banding based on the computed frequency of the light source. In another embodiment, banding correction unit 120 uses the standard deviation of the distance between the zero crossing points to determine whether there is periodic pattern, and corrects banding so that the periodic pattern no longer exists. In FIG. 3B, the x axis corresponds to the row index divided by four, and the y axis corresponds to the row sum difference intensity value. In the example of FIG. 3B, the standard deviation of the distance between zero crossing points is approximately three percent.

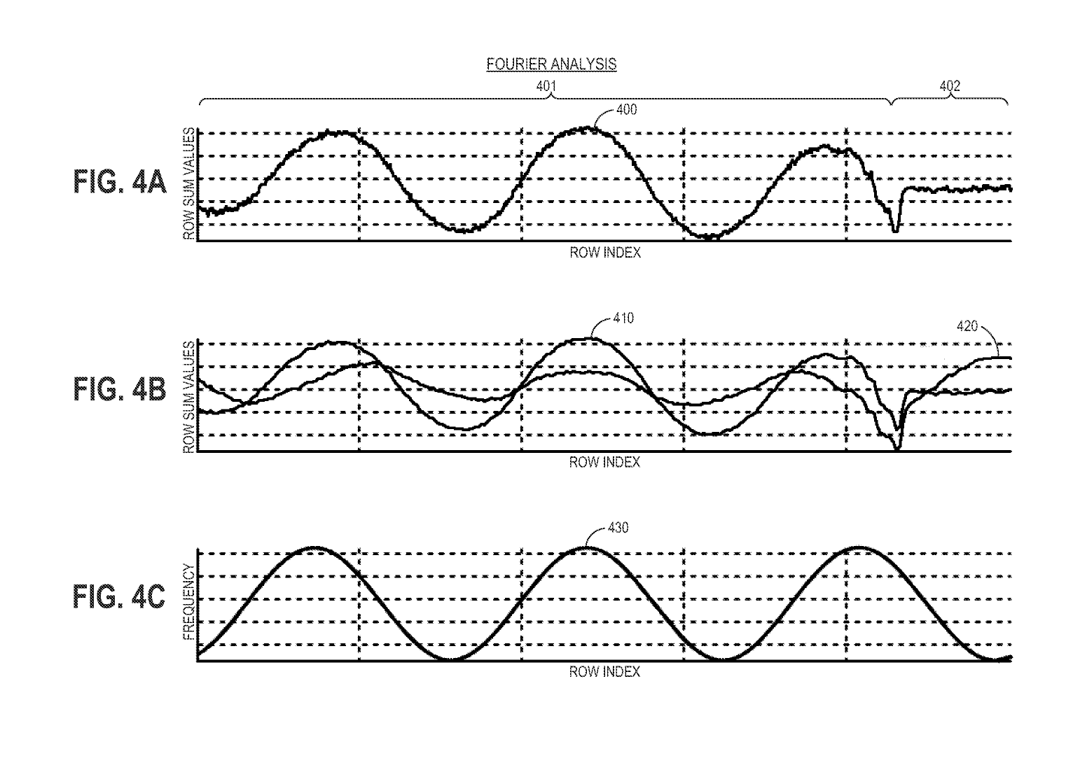

FIGS. 4A-C illustrate the signals used at the various steps of an exemplary Fourier analysis process for identifying a periodic signal in row sum data of a divided region of a frame, which may be used by the modules of the static band circuit 150 for detecting static banding. However, it will be appreciated that the illustrated signals are for illustrative purposes only, and the appearance of actual row sum data may vary, particularly if no static banding is present in the divided region.

FIG. 4A illustrates row sum data 400, where the x-axis of the plot represents a row index and the y-axis of the plot represents row sum values of the row or rows summed at each row index. Row sum plot 400 corresponds to the output of row sum calculator 152 for a divided region of a frame. A first portion 401 of the row sum data 400 exhibits an approximate periodic pattern due to static banding present in the divided region of the frame. A second portion 402 of the row sum data 400 does not exhibit a periodic pattern, which may be due to objects or artifacts in the divided portion which mask or interfere with the periodic signal of static banding.

FIG. 4B illustrates an approximation of the residue 420 present in the row sum data 400, where the x-axis of the plot represents a row index and the y-axis of the plot represents row sum values. To illustrate calculation of residue 420 present in the row sum data 400, a signal can be approximated as a linear combination of N Fourier series. Low level Fourier series represent low frequency components while high level Fourier series represent high frequency components. The residue represents a difference between the actual signal, represented by the row sum data 400, and the approximated signal 410 illustrated in FIG. 4B. Using higher level Fourier series in approximation can result in less residue. Residue can be used to evaluate how close the approximated signal 410 is to the row sum data 400. FIG. 4B also illustrates a signal approximation 410, which approximates a periodic signal present in the row sum data 400 due to static banding. The signal approximation 410 is calculated by subtracting the residue 420 from the row sum data 400, and corresponds to the output of the residue removal module 153.

FIG. 4C illustrates the periodic signal approximation 410 with a Fourier transform applied to determine the periodic static banding signal 430 at the target frequency, where the x-axis of the plot represents a row index and the y-axis of the plot represents frequency values of the ambient light incident upon the pixel or pixels at each row index. The Fourier analysis may be, in some embodiments, an eight-level Fourier decomposition which filters out high frequencies in the row sum data. In some embodiments, the amplitude of the periodic signal 430 may be related to the total energy of the row sum data.

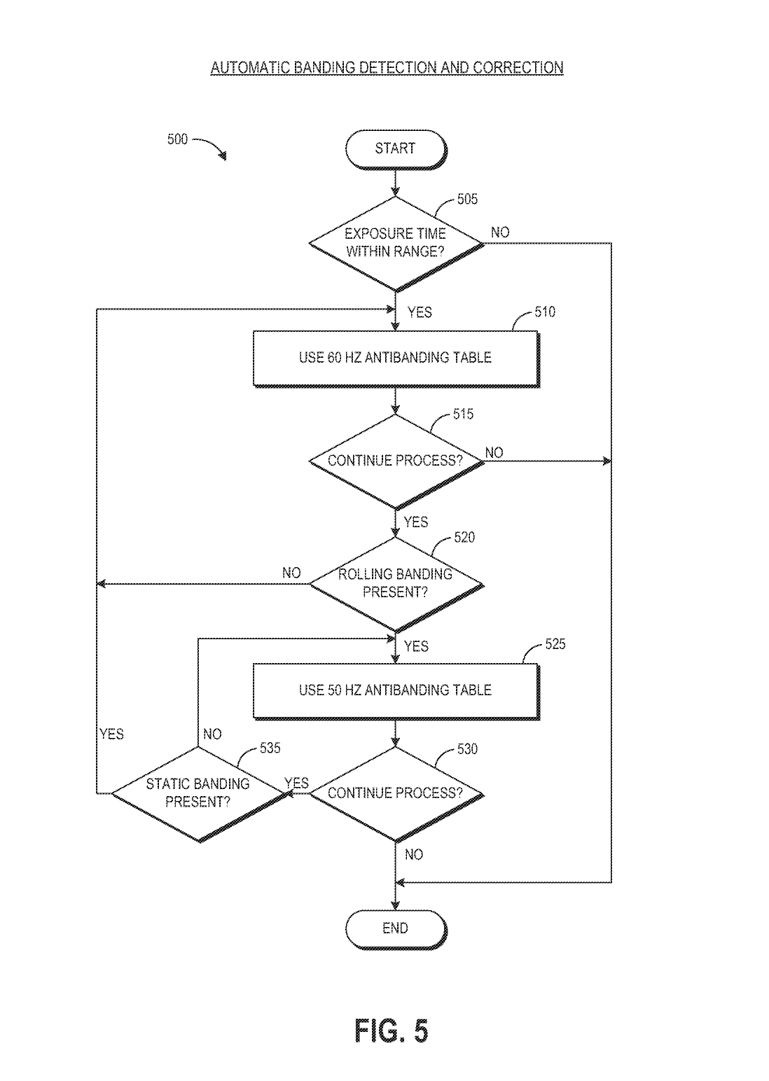

FIG. 5 illustrates an embodiment of an automatic banding detection process 500 which may take place in the banding correction unit 120 of FIG. 1A. The process 500 may be used to detect a power line frequency of ambient light when the frequency is unknown, and may also be used to detect what frequency is present in a target image scene when multiple power line frequencies are present in the scene environment. To begin, at step 505 auto exposure control (AEC) may be set such that the exposure, or integration, time is within a specified range, for example between approximately 8.33 ms and 40 ms. Some embodiments may employ this range because during exposure times longer than approximately 40 ms banding gets averaged and is not visibly apparent in a captured image, and because exposure times shorter than 8.33 ms may be less than one banding cycle and therefore banding may not be able to be corrected. In some embodiments a user or an automated exposure control routine may set the integration to a time outside of the specified range. Therefore, at step 505 the process 500 determines whether integration time is within the specified range, and if integration time is outside of the range then the process 500 ends.

If the integration time is within the specified range, the process 500 may move to step 510, in which an antibanding correction table for a first power line frequency of ambient light, for example 60 Hz, is selected to use in determining whether rolling banding is occurring in the captured image frames. In some embodiments, the 60 Hz antibanding correction table may be used by default, wherein it is assumed that the power line frequency of ambient light is 60 Hz, and therefore only 50 Hz must be detected. After selecting the 60 Hz antibanding correction table, the process 500 moves to step 515 in which whether to continue the process 500 is determined. If the process 500 should not be continued, for example because the image capture device has been idle for a specified time period, a user is initiating image capture, or the process 500 has detected that only one power line frequency of ambient light is present in the target scene environment, then the process 500 ends. If the process 500 ends because the user is initiating image capture, then a currently selected antibanding correction table is output for banding correction in the captured image.

If the process 500 should continue, then the process 500 checks for rolling banding using the 60 Hz antibanding table. In a 50 Hz environment at an integration time of 33.33 ms, or 30 frames per second, rolling banding will be detected using the 60 Hz antibanding correction table. Therefore, the process 500 presumes that the power line frequency of ambient light in the image scene environment is 60 Hz, and uses the 60 Hz antibanding correction table to determine whether the presumption of 60 Hz is correct. If no rolling banding is detected, then the power line frequency of ambient light is approximately 60 Hz, and the process 500 loops back to step 510 to use the 60 Hz antibanding table to detect any banding artifacts in captured images. After a specified period of time, the process 500 may recheck whether rolling banding is still detected. If rolling banding is still not detected, then the process 500 would again loop back to step 510 use the 60 Hz antibanding table for banding correction.

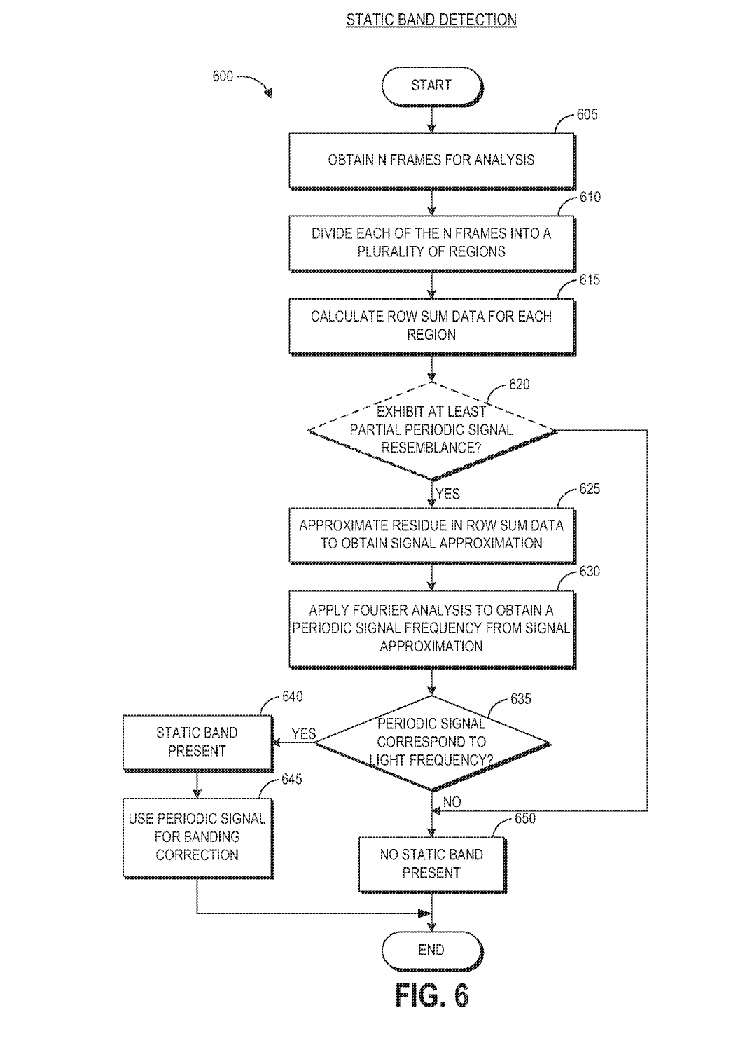

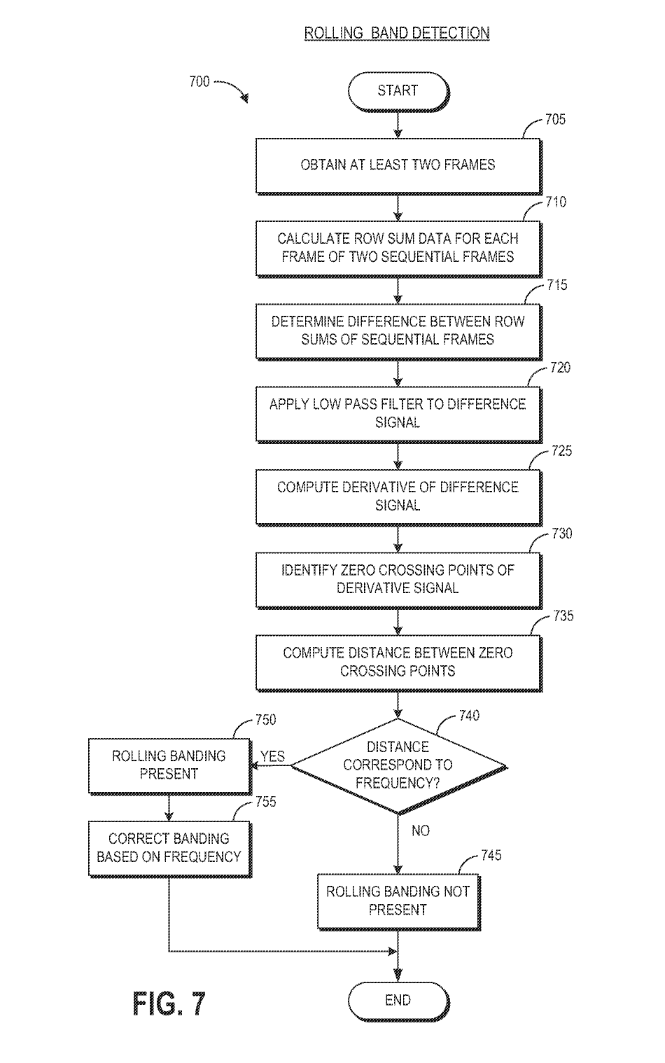

If rolling banding is detected using the 60 Hz antibanding correction table, then the power line frequency of ambient light is presumed to be 50 Hz and the process 500 moves to step 525, in which a 50 Hz antibanding correction table is selected for determining whether banding is occurring in captured image frames. Using the 50 Hz antibanding correction table, the process 500 can check for stationary, or static, banding. In a 60 Hz environment at the common integration time of 30 fps, using the 50 Hz antibanding correction table will detect static banding. The process 500 moves to step 530 to check whether to continue determining what power line frequency is being used for ambient light. If the process 500 should continue, then the process 500 moves to step 535 to check for static banding. If no static banding is detected, then the power line frequency of ambient light is approximately 50 Hz, and the process 500 loops back to step 525 to use the 50 Hz antibanding correction table for banding correction. If static banding is detected, then the power line frequency of ambient light is approximately 60 Hz, and the process 500 will loop back to step 510 to use the 60 Hz antibanding table to correct banding. This process of rechecking for rolling or static banding with the two antibanding correction tables may continue in a perpetual cycle for a specified period of time, for example during image capture, or when an image capture device is powered on. Exemplary static band detection and rolling band detection methods will be discussed in more detail below with respect to FIG. 6 and FIG. 7, respectively.

The 60 Hz and 50 Hz antibanding tables are sensor-dependent, and may be calculated on the fly. As such, the tables are adaptable to power line frequency variation as well, and may be recalculated if the determined power line frequency is not exactly 50 Hz or 60 Hz. Therefore, it will be appreciated that the 50 Hz and 60 Hz antibanding tables referred to in the description of FIG. 5 are for illustrative purposes only, and that antibanding tables for any two or more frequencies could be employed in the banding detection process. Although the process 500 does not detect the scenario of no banding present in an image, for example an image taken in sunlight exhibits no banding, images with no banding taken using an exposure time within the specified range will use the 60 Hz antibanding correction table. However, images taken in sunlight typically have exposure times smaller than 8.3 ms, and so the process 500 would end after step 505 before an antibanding correction table was selected.

FIG. 6 is an embodiment of a static band detection and correction process 600 which may take place in the banding correction unit 120 of FIG. 1A, specifically within the static band circuit 150 of FIG. 1B, and which may employ the Fourier analysis illustrated in FIGS. 4A-C. To begin, the process 600 may obtain N frames for analysis at step 605, where in some embodiments N may be six. In other embodiments any number of frames may be used. The process 600 then moves to step 610 in which each of the N frames is divided into a plurality of vertical regions, which may be carried out by the frame divider 151. As discussed above, dividing the frames into vertical regions improves the robustness of the static band detection process, as it may be easier to detect static banding in a region of an image frame which does not exhibit a periodic pattern due to the objects in the image scene.

The process 600 then moves to step 615 in which row sum data is calculated for each divided region, for example by row sum calculator 152. As discussed above, the row sum calculator 152 may employ a sliding window method and only calculate row sums for at least two portions of the divided regions. Row sum calculator 152 may sum each of the rows of the divided portions or may group a number of rows together and calculate a single row sum for the entire group. In some embodiments, all divided regions may be processed by a module of the static band circuit 150 before the information about the divided regions is passed to the next module. In other embodiments, each divided region may be processed by the entire static band circuit 150 before the next divided region, and if static banding is detected in any region then the entire frame may be determined to exhibit static banding and subsequent divided regions may not be processed.

Optionally, after calculating row sum data, the process 600 may make a preliminary determination at step 620 regarding whether the at least a portion of the row sum data for a region resembles a periodic signal, such as the first portion 401 of the row sum data 400 of FIG. 4A. If there is no partial periodic signal resemblance, then the process 600 may move to step 650 in which it is determined that no static band is present and then the process 600 may end. If there is at least a partial periodic signal resemblance, then the process 600 moves to step 625 in which residue present in the row sum data is approximated and then subtracted from the row sum data to obtain a periodic signal approximation. This may be executed, for example, by the residue removal module 153 of FIG. 1B.

The process 600 then transitions to step 630, in which a Fourier analysis is applied to the periodic signal approximation to obtain a periodic signal frequency. Step 630 may be executed by the Fourier analysis module 154. The process 600 then moves to step 635 to determine whether the periodic signal corresponds to a power line frequency of ambient light, for example 50 Hz or 60 Hz. If the periodic signal does not correspond to a power line frequency of ambient light, then the process 600 moves to step 650 in which it is determined that no static band is present and then the process 600 may end. If the periodic signal does correspond to a power line frequency of ambient light, then the process moves to step 640 in which it is determined that at least one static band is. The process 600 then transitions to step 645 in which the periodic signal is used to generate a banding correction signal before the process 600 ends.

FIG. 7 is an embodiment of a rolling band detection and correction process 700 which may take place in the banding correction unit 120 of FIG. 1A, specifically within the rolling band circuit 140 of FIG. 1B, and which may employ the row sum data 200 and difference row sum data 300 illustrated in FIGS. 2 and 3, respectively.

The process 700 begins at step 705, in which the rolling band circuit 140 obtains at least two frames. The process 700 then transitions to step 710, in which the row sum data is calculated for each frame. This may take place in the row sum calculator 141, where the row sum calculator 141 sums the intensity values across at least a portion of the sensors of at least a portion of the rows for the frames. The row sum calculator 141 may compute the row sums serially or in parallel. As described above, row sum calculator 141 may sum each of the rows of the frames output by sensor array 105 or group a number of rows together and calculate a single row sum for the entire group.

Next, the process 700 moves to step 715, in which the difference between the row sums of sequential frames are determined. Computing the difference between the rows removes scene information and the result is banding information. This step may be executed by the frame comparator 142. Frame comparator 142 may, for example, subtract each row sum of the first frame from the corresponding row sum of the second frame to obtain the difference signal indicating the row sum differences between the two frames. The frame comparator 142 may clip the negative or positive portion of the difference signal to zero.

Next, the process 700 moves to step 720 in which a low pass filter is applied to the difference signal to remove unwanted high frequency patterns from the difference signal, thus reducing the effects caused by hand jitter or motion among the two frames. This may be accomplished by the low pass filter 143 of the rolling band circuit 140. The process 700 then moves to step 725 in which the derivative of the difference signal is computed. For example, the derivative calculator 144 may compute the derivative of the filtered difference signal. The process 700 then moves to step 730 to identify the zero crossing points of the derivative signal. Next, at step 735, the process 700 computes the distances between the zero crossing points and the standard deviation of the distances between zero crossing points. The distances between the zero crossing positions correspond to the distances between the peak values of the filtered difference signal. Steps 730 and may be executed by banding correction module 155.

At step 740, the process 700 determines whether the distances between the zero crossing points correspond to a periodic signal at a power line frequency of an illumination source. The standard deviation of the distances between crossing points may be compared to a threshold value to determine whether a periodic pattern indicative of banding is present. If the standard deviation is less than the threshold value, a periodic pattern indicative of banding is present, and the frequency may be calculated. For example, the banding correction module 155 may calculate the frequency F of the illumination source according to the formula:

F=(1/(peak_distance*row_{—}time))/2 (1)

In the above formula (1), the value “peak_distance” represents the distance, in rows, between peaks of the filtered distance signal, as determined by the zero crossing points of the derivative signal. The value “row_time” represents the time required by image capture device 100 to readout an individual row, i.e., the scan time per row.

In an exemplary embodiment, the frequency F of the illumination source may be calculated according to the following formula:

F=((viewfinderRows*scale+croppedRows)/(peak_distance*scale*frame_rate))/2 (2)

In the above formula (2), as in formula (1), the value “peak_distance” represents the distance, in rows, between peaks of the filtered distance signal, as determined by the zero crossing points of the derivative signal. The value “frame_rate” represents the rate at which frames are acquired by image capture device 100, e.g., frames per second. In formula (2), the value “viewfinderRows” represents the number of rows used by image capture device 100 to drive a viewfinder or other image display device associated with the image capture device. The number of rows used to drive the viewfinder will ordinary be less than the total number of rows in the frame obtained by image capture device 100.

The value “scale” in formula (2) represents a downsampling factor applied to the number of rows obtained by image capture device 100 to produce a viewfinder video frame. The value “croppedRows” represents the number of rows cropped from the total frame to drive the viewfinder. More particularly, the value “croppedRows” may represent the sum of the number of rows cropped that is associated with scaling, the number of rows cropped by a demosaic function, the number of rows used for VBLT (vertical blanking time), and any number of “dummy” rows that do not contain scene information. In this manner, the value “viewfinderRows*scale+croppedRows” in formula (2) represents all rows in a captured frame.

If the distance between zero crossing points corresponds to an illumination source frequency, for example the process 700 may be checking for rolling banding at 50 Hz or 60 Hz, then the process 700 moves to step 750 in which it is determined that rolling banding is present. The process 700 then moves to step 755 to correct banding based on the frequency. For example, banding correction module 155 may correct the flicker based on the identified illumination source frequency F.

### Terminology

Implementations disclosed herein provide systems, methods and apparatus for generating a stereoscopic image with an electronic device having one or more imaging sensors. The present embodiments further contemplate monitoring the position of a user's eyes and adjusting a mask over a display of the electronic device in response. One skilled in the art will recognize that these embodiments may be implemented in hardware, software, firmware, or any combination thereof.

In the following description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

Headings are included herein for reference and to aid in locating various sections. These headings are not intended to limit the scope of the concepts described with respect thereto. Such concepts may have applicability throughout the entire specification.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. A method, implemented in an image capture device, of detecting image banding comprising:
capturing a plurality of frames of an image at a selected framerate;
attempting to correct banding artifacts in the captured plurality of frames using a first antibanding correction table;
determining whether rolling banding is present in the captured plurality of frames at the selected framerate; and
detecting whether rolling banding is present, wherein if rolling banding is present then selecting a second antibanding correction table configured to correct the rolling banding, and wherein if rolling banding is not present then using the first antibanding correction table to correct banding artifacts in the image capture device.

2. The method of claim 1, further comprising determining whether an exposure time is within a specified range.

3. The method of claim 1, wherein the first antibanding correction table corresponds to a first power line frequency of ambient light and the second antibanding correction table corresponds to a second power line frequency of ambient light.

4. The method of claim 1, wherein the first power line frequency is 60 Hz and the second power line frequency is 50 Hz.

5. The method of claim 4, wherein determining whether rolling banding is present comprises determining whether rolling banding is present at 60 Hz.

6. The method of claim 5, further comprising determining whether static banding is present at 50 Hz.

7. The method of claim 6, wherein if static banding is present at 50 Hz, the method further comprises using the second antibanding correction table to correct banding artifacts in the image capture device.

8. The method of claim 6, wherein if static banding is not present at 50 Hz, the method further comprises using the first antibanding correction table to correct banding artifacts in the image capture device.

9. The method of claim 1, further comprising cycling between determining whether one of static and rolling banding is present at a first power line frequency and determining whether the other of static and rolling banding is present at a second power line frequency.

10. An image capture device comprising:
at least one sensor configured to capture a plurality of image frames of a target image;
a capture control unit configured to control the at least one sensor; and
a banding correction unit configured to:
receive the plurality of image frames,
detect a type of banding present in the plurality of image frames,
select an antibanding method based at least in part on the detected type of banding present, and
use the antibanding method to generate a banding correction signal.

11. The image capture device of claim 10, wherein the type of banding is one of rolling banding and static banding.

12. The image capture device of claim 10, wherein the capture control unit is further configured to receive the banding correction signal and to adjust the at least one sensor using the banding correction signal to substantially eliminate banding in the target image.

13. The image capture device of claim 10, the banding correction unit comprising a rolling band circuit and a static band circuit.

14. The image capture device of claim 14, the banding correction unit further comprising a banding type module configured to:
receive the plurality of image frames,
access the type of banding to detect, wherein the type of banding is one of rolling banding and static banding, and
output the plurality of image frames to the rolling band circuit if the accessed type of banding is rolling banding or output the plurality of image frames to the static band circuit if the accessed type of banding is static banding.

15. The image capture device of claim 14, the banding correction unit further comprising a banding correction module configured to output a banding correction signal based on a signal received from one of the rolling band circuit and the static band circuit.

16. The image capture device of claim 10, wherein the banding correction unit comprises a frame divider configured to divide each of the plurality of image frames into a plurality of regions.

17. The image capture device of claim 16, wherein the regions are vertical regions.

18. The image capture device of claim 16, the banding correction unit further comprising a row sum calculator configured to generate row sum data for each of the plurality of regions.

19. The image capture device of claim 18, the banding correction unit further comprising a residue removal module configured to approximate the residue present in the row sum data and to produce a signal approximation by subtracting the residue from the row sum data.

20. The image capture device of claim 19, the banding correction unit further comprising a Fourier analysis module configured to generate a periodic signal from the signal approximation and to determine whether the periodic signal corresponds to static banding at a frequency of ambient light.

21. The image capture device of claim 20, wherein a static band circuit comprises the frame divider, row sum calculator, residue removal module, and Fourier analysis module.

22. The image capture device of claim 19, the banding correction unit further comprising a banding correction module configured to generate a banding correction signal from the periodic signal.

23. A static band detection device comprising:
means for obtaining a plurality of frames of a target image;
means for dividing each of the plurality of frames into a plurality of regions;
means for calculating row sum data for each region;
means for obtaining a periodic signal from the row sum data; and
means for determining whether the periodic signal indicates that static banding is present in at least one of the regions.

24. The static band detection device of claim 23, the means for obtaining a periodic signal from the row sum data comprising:
means for obtaining a signal approximation by approximating residue in the row sum data and removing the residue from the row sum data; and
means for obtaining a periodic signal from the signal approximation.

25. A non-transitory computer-readable medium storing instructions which, when executed, cause a processor to:
capture at least two image frames using an image capture device;
calculate row sum data for the at least a portion of the at least two image frames;
detect a type of banding present in the row sum data, wherein the type of banding comprises one of rolling banding and static banding;
select an antibanding table based at least in part on the detected type of banding; and
correct banding in an additional image frame captured by the image capture device based on the selected antibanding table.

26. The non-transitory computer-readable medium of claim 25, wherein, to calculate row sum data for the at least a portion of the at least two image frames, the instructions further cause the processor to:
divide each of the at least two image frames into a plurality of regions; and
calculate row sum data for each of the plurality of regions.

27. The non-transitory computer-readable medium of claim 26, the instructions further causing the processor to:
detect whether static banding is present in the row sum data of at least one of the plurality of regions.
